(19) United States
(12) Patent Application Publication
(10) Pub. No.: US 2012/0132183 A1
(43) Pub. Date: May 31, 2012

(54) HIGH CETANE RENEWABLE FUELS

(75) Inventors: Gary Clyde GUNTER, Bartlesville, OK (US); Edward T. CASEY, Bartlesville, OK (US); Thomasin C. MILLER, Houston, TX (US); Matthew J. TRUITT, Bartlesville, OK (US)

(73) Assignee: CONOCOPHILLIPS COMPANY, Houston, TX (US)

(21) Appl. No.: 13/304,819

(22) Filed: Nov. 28, 2011

Related U.S. Application Data
(60) Provisional application No. 61/418,187, filed on Nov. 30, 2010.

(51) Int. Cl. F02M 25/07; C10L 1/19

(52) U.S. Cl. 123/568.11; 44/388

(57) ABSTRACT

A method for reducing the emissions of a diesel engine using a RHE-diesel fuel.

### CROSS-REFERENCE TO RELATED APPLICATIONS

This application is a non-provisional application which claims benefit under 35 USC §119(e) to U.S. Provisional Application Ser. No. 61/418,187 filed Nov. 30, 2011, entitled “HIGH CETANE RENEWABLE FUELS,” which is incorporated herein in its entirety.

### FIELD OF THE INVENTION

The following relates to diesel combustion, and more particularly to reducing emissions associated with diesel combustion.

### BACKGROUND OF THE INVENTION

Diesel fuels are available from a variety of sources with a variety of desirable and undesirable properties. Diesel fuel provides better lubricity than other petroleum fuels and the diesel engine offers more efficient combustion than a standard gasoline engine. Unfortunately diesel engines are frequently associated with increased pollution, including NO_{X}, particulate, and other emissions. Direct-injection diesel engines can significantly increase fuel economy without sacrificing attributes and will likely meet or exceed increasing emission standards with additional improvements.

Diesel engines are a well established technology in Europe that captured over half of the passenger car market in model years 2007-2008 (Schmidt's, 2010). Developing a highly efficient diesel system with an efficient engine and quality fuel will lead to greater adoption of diesel fuels in the future. As diesel engines improve, they continue to reduce emissions and improve fuel economy.

Diesel fuels are readily available from a variety of sources including, petroleum based diesel (petrodiesel), FAME biological diesels (biodiesels), synthetic diesel, and others. Diesels may be incorporated and blended to meet market needs, government standards, and higher environmental initiatives. Currently, the vast majority of diesel fuel is derived from petroleum sources although biofuels and synthetic diesels are being developed. Unfortunately, to date renewable biofuels and synthetic diesels are far too expensive to be competitive with current, crude-derived diesel fuels.

In order to meet ever increasing diesel emission standards, reduce fuel consumption, and meet current diesel fuel requirements, an inexpensive source of diesel fuel with low emissions is required.

### BRIEF SUMMARY OF THE DISCLOSURE

The invention more particularly includes renewable high-efficiency diesel (RHE-diesel) fuel blends with high cetane values including fuel blends with long chain fatty acid esters.

In one embodiment, a RHE-diesel fuel contains high paraffin diesel with hydrotreated tallow or vegetable oil. In another embodiment, the RHE-diesel fuel contains esters, ethers and/or hemiacetals comprising alcohols, polyols and combinations of esters, ethers and hemiacetals. In yet another embodiment, the RHE-diesel fuel blending agent contains mixtures of high paraffin diesel with hydrotreated tallow, vegetable oil, esters, ethers and hemiacetals.

Additionally, the emissions of a diesel engine are reduced when combusting a RHE-diesel fuel containing either a high paraffin diesel comprising hydrotreated tallow or vegetable; esters, ethers and hemiacetals comprising alcohols, polyols and combinations thereof; or combinations of high paraffin diesels and esters, ethers and/or hemiacetals. Fuel efficiency is improved when the RHE-diesel fuel is injected at from −8 to 0 degrees After Top Dead Center (ATDC), and the engine is operated with an exhaust gas recirculation (EGR) of from 20 to 60%.

The RHE-diesel fuel may contain short chain paraffins from C8, C9, C10, C11, C12, C13, C14, to C15 paraffins. The RHE-diesel fuel may also contain long chain paraffins from C15, C16, C17, C18, C19, C20, C21, C22, C23, C24, C25 to C26 isoparaffins, wherein the side chains have 1-5 carbons in each of the side chains, and less than 50 percent of the total carbons are in side chains. The RHE-diesel fuel may contain long chain esters, ethers and hemiacetals (C8-26) selected from the group consisting of methyl esters, 1,2-ethanediols, 1,3-propanediols, 1,4-butanediols, 2,3-butanediols, and the like, said long chain esters, ethers and hemiacetals containing a total of 10, 11, 12, 13, 14, 15, 16, 17, 18, 19, 20, 21, 22, 23, 24, 25 or 26 carbon atoms in a linear or branched chain with oxygen. The RHE-diesel fuel may contain transesterification products of alcohols, polyols, carboxylic acids, and fatty acids. The RHE-diesel fuel according may contain ethers (dipentyl and dihexyl ether) made from condensation of alcohols, polyglycol ethers terminated with alkane groups made from condensation of glycols followed by capping with olefins, polyglycol ethers terminated with alkane groups made from condensation of glycols followed by mild hydrodeoxygenation of terminal hydroxyl groups, polyglycol ethers terminated with olefinic groups made from condensation of glycols followed by dehydration of terminal hydroxyl groups, polydiol ethers terminated with alkane groups made from condensation of glycols followed by capping with olefins, polydiol ethers terminated with alkane groups made from condensation of glycols followed by mild hydrodeoxygenation of terminal hydroxyl groups, polydiol ethers terminated with olefinic groups made from condensation of glycols followed by dehydration of terminal hydroxyl groups, mixed ethers, acetals, hemiacetals, dehydrated hemiacetals formed by dehydrogenation of hydroxyl containing compounds, and combinations thereof.

In one embodiment the RHE-diesel fuel has a cetane number greater than that of conventional diesel fuel, including a cetane number of about 51 to about 81, including a high efficiency diesel fuel with a derived cetane number of about 60, about 65, about 70, about 75, about 80, about 45 to 51, about 51 to 81, or above about 81, or greater than 85. In another embodiment, the RHE-diesel fuel has a combustion efficiency of from 98.19% to 98.69%, reduced NOX emissions from 0.63 g/kgfuel to 2.01 g/kgfuel, reduced particulate matter emissions of from 0.45 g/kgfuel to 0.71 g/kgfuel, reduced total hydrocarbon emissions of from 2.01 g/kgfuel to 3.69 g/kgfuel, reduced carbon monoxide emissions of from 8.62 g/kgfuel to 13.98 g/kgfuel. In some examples, the RHE-diesel fuel results in an increase in brake thermal efficiency of greater than 1.0%, including at least 1.5%. In yet another example, the RHE-diesel fuel results in a decrease in nitrogen oxide (NOx) emissions of greater than 10%, including at least about 17%, 18%, 19%, 20% or greater, compared to an identical method wherein the fuel is a diesel fuel. Other improvements may include a decrease in particulate matter emissions of greater than 55%, including about 63%, 65%, 68%, 70%, or greater, compared to an identical method wherein the fuel is a diesel fuel; a decrease in total hydrocarbon emissions of greater than 75%, including at least about 80%, 85% 90% or greater, compared to an identical method wherein the fuel is a diesel fuel; a decrease in carbon monoxide emissions of greater than 70%, including greater than 75%, 80%, or greater, compared to an identical method wherein the fuel is a diesel fuel.

The RHE-diesel fuel can be a blended diesel fuel stock comprising one or more components including a RHE-diesel fuel, a cetane enhancer, an LTFT fuel, high-cetane distillates, high-cetane straight-run distillate, high-cetane overhead products, paraffins, isoparaffins, ethyl hexyl nitrate (EHN), and combinations thereof.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

Abbreviations are used in this application, including the following: after top dead center (ATDC), brake specific fuel consumption (BSFC), brake thermal efficiency (BTE), carbon monoxide (CO), derived cetane number (DCN), electronic control unit (ECU), end of injection (EOI) timings, exhaust gas recirculation (EGR), high efficiency clean combustion (HECC), high temperature Fischer-Tropsch (HTFT) fuel, homogenous charge compression ignition (HCCl) combustion, hydrocarbon (HC), ignition delay (ID), insoluble fraction (ISF), low temperature combustion (LTC), low temperature Fischer-Tropsch (LTFT) fuel, modulated kinetics (MK), nitrogen oxides (NO_{X}), Paraffin Enhanced Clean Combustion (PECC), particulate matter (PM), pre-mixed charge compression ignition (PCCI) combustion, rate of heat release (ROHR), smokeless locally rich diesel combustion (SRDC), soluble organic fraction (SOF), spark ignited (SI), start of combustion (SOC), start of injection (SOI), top-dead-center (TDC), and total hydrocarbons (THC).

Researchers have developed highly efficient diesel engines, including light-duty turbodiesel engines that may be operated in an advanced diesel combustion mode, specifically high efficiency clean combustion (HECC). See “Advanced Diesel Combustion with Low Hydrocarbon and Carbon Monoxide Emissions,” U.S. App. No. 61/375,334 filed on Aug. 20, 2010 is hereby incorporated by reference in its entirety. Combustion of three different fuels including a conventional diesel fuel, an HTFT fuel, and an LTFT fuel identified high ignition quality (DCN 81) fuels as ideally suited for operation under a high EGR advanced diesel mode and led to reductions in all primary pollutant emissions. Paraffin Enhanced Clean Combustion (PECC) is one synergetic combination of advanced diesel combustion techniques and a highly paraffinic synthetic diesel fuel that led to a simultaneously reduction of NO_{X}, PM, THC, CO emissions while maintaining thermodynamic efficiency.

Modifications of fuel composition and fuel properties have the potential to optimize PCCI operation processes, such as HECC, and eliminate undesirable effects arising from increasing the fraction of pre-mixed combustion. Fuel properties are directly dictated by the molecular structure of the hydrocarbons in the fuel. Normal alkanes, branched alkanes, cycloalkanes, alkenes and aromatics account for the major species that comprise conventional liquid hydrocarbon fuels.

Cetane number (CN) is a measure of the ease with which a diesel fuel ignites by compression. It is a specification of the fuel ignition quality and is quantified by the delay between the time of injection into an engine and the start of combustion. The shorter the ignition delay period, the higher the CN. CN is often seen as a fuel property that reflects various fuel performance characteristics, such as cold startability, cold smoke, noise, power, fuel consumption, and exhaust emission. Chemically it is more accurate to consider CN not as a property, but as “a variable dependent on the chemical composition of the fuel” (Indritz, 1985). The primary reference fuels for the CN test are 2,2,4,4,4,6,8,9-heptamethylnonane (also known as HMN or isocetane, CN=15) and hexadecane (also called cetane, CN=100). Other cetane standards have been used in the past and many must be converted to today's CN standard, dependent upon the reference fuel used and method of measuring CN. CN may also be measured by using secondary reference fuels rather than the primary reference fuels just mentioned above. Two current secondary reference fuels are designated U-11 (CN=20.5) and T-18 (CN=75), combinations of which are used as bracketing reference fuels for unknowns with CN in the range 20.6-75. For unknowns with 15<CN<20.5, HMN and U-11 are used. For unknowns with 75<CN<100, T-18 and cetane are used. A typical conventional diesel fuel ranges in cetane number between 40 and 55.

Octane number (ON) is an engine test that determines the knocking tendency of gasoline-type fuels. ON is the resistance of the fuel to compression ignition in the end gas (i.e., the part of fuel/air mixture in the cylinder that has not yet been ignited by the flame front). While CN is a measure of ease of compression ignition, ON is a measure of resistance to it. Therefore, the two ignition properties correlate with each other inversely. Generally speaking, the octane number of hydrocarbons increases as the energy of their C—H and C—C bonds increases in the series, n-alkanes<isoalkanes<alkenes<cycloalkanes<aromatic hydrocarbons. The CN decreases in the same series of hydrocarbons. Also, the CN increases as the molecular weight of a hydrocarbon is increased. Although there is a generally inverse correlation between CN and ON, because of the multiple properties that go into CN and ON, the relationship may not be directly proportional under all conditions. Desirable fuel combustion properties may lead to variances in CN, ON, cold startability, cold smoke, noise, power, fuel consumption, exhaust emissions, and other properties that improve fuel quality without a corresponding changes in all of the fuel properties.

A RHE-diesel fuel (RHE-diesel) includes diesels produced through esterification, condensation, and other reactions wherein hydrocarbons are produced from biological sources through a variety of chemical reactions or combinations of chemical reactions. Because the RHE-diesel is “high-efficiency” it produces fewer emissions, pollutants and the like; generates more force or energy during combustions; and/or is combusted more completely than a traditional diesel under the same combustion conditions.

Materials and methods provided below are examples of measurements and data that may be collected to analyze diesel fuel quality and efficiency. The methods provided below are non-limiting examples of analysis techniques that are used for diesel fuel testing. One or more of these methods may be used to determine the quality and efficiency of the fuels developed herein.

In one embodiment, a common rail turbodiesel engine may be operated in the HECC advanced diesel combustion mode. The engine is operated at steady state conditions with a constant speed and load. The start of injection (SOI) timing command may be swept from −8° ATDC to 0° ATDC to find an optimized injection condition for each fuel tested. Low NO_{X}, PM, THC and CO emissions may be achieved, while preserving thermal efficiency by combining an advanced combustion process with a high ignition quality fuel. In another embodiment a DDC/VM Motori 2.5 L, 4-cylinder, turbocharged, common rail, direct injection, Euro 3 compliant light-duty diesel engine with an unlocked electronic control unit (ECU) may be coupled to a 250HP Eaton eddy current water-cooled dynamometer. The engine and dynamometer is controlled by a DIGALOG TESTMATE™ control unit.

Particulate matter (PM) may be sampled through a Sierra Instruments BG-3 micro-dilution tunnel using a dilution ratio of 10:1 with a sampling duration of 5 minutes for each of the three filters acquired per test mode. The BG-3 micro-dilution tunnel sampling parameters may be optimized to collect particulate samples over the widest range of test points. Soxhlet extraction is performed on the PM filters using dichloromethane as a solvent for 24 hours with approximately 300 wash cycles.

An AVL Combustion Emissions Bench II (CEB-II) (AVL, Graz, Austria) is used to measure gaseous emissions. NO_{X} and NO are measured using an EcoPhysics chemiluminescence analyzer. Without additional analysis, NO₂ is assumed to be the difference between NO_{X} and NO. Total hydrocarbons and methane can measured by using ABB flame ionization detectors. Total hydrocarbons are reported on the basis of C₃, by using a propane-N₂ mixture as the calibration gas. CO and CO₂ may be measured by two separate Rosemount infrared analyzers, and O₂ can be measured by using a Rosemount paramagnetic analyzer. Hot exhaust samples going to CO, CO₂, and O₂ analyzers may be chilled or dried to reduce moisture. Emissions were reported on the basis of dry moles. Temperature, pressure, and emissions data can be sampled at a variety of intervals, in one example samples are measured every 10 seconds under steady state operating conditions.

Pressure traces can be measured using AVL GU12P pressure transducers, in place of glow plugs in one or more of the four cylinders. The voltages from the pressure transducers may be amplified for example by Kistler type 5010 dual mode amplifiers (Kistler Holding AG, Winterthur, Switzerland). Voltages, either direct or amplified, can be recorded by an AVL INDIMODUL 621 data acquisition system. Needle lift data were collected from a Wolff Controls Inc. Hall-effect needle lift sensor, which was placed on the injector of cylinder 1. The needle lift signal was also collected by the INDIMODUL, which was triggered by a crank angle signal from an AVL 365C angle encoder placed on the crankshaft. The pressure traces and needle lift data were recorded at a resolution of 0.1 crank angle degrees, and were averaged over 200 cycles. The real-time IndiModul data was transferred to a PC, which ran AVL INDICOM 1.3 and CONCERTO 3.90 software to calculate the apparent heat release rate (AVL CONCERTO SoftVersion 3.9 Software Guide, 2006).

RHE-diesel may be produced from a variety of feedstocks including animal fats including tallow, lard, yellow grease, chicken fat, virgin oil feedstock; rapeseed oils, soybean oils, pennycress (Thlaspi arvense), jatropha, mustard, flax, sunflower, palm oil, coconut, hemp, waste vegetable oil (WVO); Omega-3 fatty acids from fish oil, algae, halophytes such as Salicornia bigelovii, fungus such as Cunninghamella japonica, and Gliocladium roseum, as well as many different plant, bacterial, algal, fungal, and other sources that produce oils and fatty acids.

In transesterification, oil feedstocks are blended with alcohols including methanol, ethanol, butanol, propanol, isopropanol, polyols, and other sources. Transesterification produces fatty acid esters with a variety of properties and qualities.

The following examples of certain embodiments of the invention are given. Each example is provided by way of explanation of the invention, one of many embodiments of the invention, and the following examples should not be read to limit, or define, the scope of the invention.

### Example 1

A common rail turbodiesel engine is operated in the HECC advanced diesel combustion mode. Fuels are tested against standard diesel fuels to determine CN and emission properties of each fuel type. The engine is operated at steady state conditions with a constant speed and load. The start of injection (SOI) timing command is swept from −8° ATDC to 0° ATDC to find an optimized injection condition for each specific fuel. Low NO_{X}, PM, THC and CO emissions are achieved, while preserving thermal efficiency by combining an advanced combustion process with a high ignition quality fuel. Table 1 identifies fuel properties for fuels tested and proposed for use as RHE-diesel fuels compared against conventional diesel.

The flash point of RHE-diesel (>130° C., >266° F.) is significantly higher than that of petroleum diesel (64° C., 147° F.) or gasoline (−45° C., −52° F.). RHE-diesel has a density of ˜0.88 g/cm³, higher than petrodiesel (˜0.85 g/cm³). RHE-diesel has virtually no sulfur content, and it is often used as an additive to Ultra-Low Sulfur Diesel (ULSD) fuel. RHE-diesel has a number of standards for its quality including European standard EN 14214, ASTM International D6751, and others. RHE-diesel is commonly produced by the transesterification of the vegetable oil or animal fat feedstock. There are several methods of transesterification including batch process, supercritical processes, ultrasonic methods, and microwave methods. Methyl and ethyl esters are common products as the least expensive alcohols, but any alcohol may be transesterified to achieve fatty acid esters with a variety of properties. In one embodiment one or more polyols are used for transesterification to create a branched fatty acid ester with higher cetane value. Typical RHE-diesel fuels range from C8-C26, preferably from C12-C24, but may be any length of RHE-diesel fuel with a high cetane value.

TABLE 1
Properties of fuels examined

| | | Diesel | Biodiesel | RHE-diesel |
|---|---|---|---|---|
| Density (g/cm³)^{a} | | 0.84 | 0.88 | |
| Kinematic viscosity (cSt)^{b} | | 2.5 | | |
| Heat of Combustion (MJ/kg)^{c} | | 45.7 | | |
| ppm S (wt)^{d} | | 9.7 | | |
| Carbon (mass %)^{e} | | 85.2 | | |
| Hydrogen (mass %)^{e} | | 12.8 | | |
| Nitrogen (mass %)^{e} | | 0.01 | | |
| Distillation^{f} | IBP (° C.) | 133 | | |
| | T50 (° C.) | 256 | | |
| | T90 (° C.) | 329 | | |

| | | | |
|---|---|---|---|
| Derived Cetane Number^{g} | 45 | | |
| Aromatics (vol %)^{h} | 31.5 | | |
| Olefins (vol %)^{h} | 1.7 | | |
| Saturates (vol %)^{h} | 66.8 | | |
| Methyl-esters | 0 | >10% | 25% |

Test Methods:
^{a}ASTM D-4052;
^{b}D-445;
^{c}ASTM D-240;
^{d}ASTM D-5453;
^{e}D-5291-02;
^{f}ASTM D-2887;
^{g}ASTM D-6890;
^{h}ASTM D-1319.

### Example 2

Fuels tested and proposed for use as RHE-diesel fuels compared against conventional diesel. RHE-diesel fuels are blended with conventional petrodiesel and cetane improvers to produce a high efficiency diesel blend with ultra-low emissions. By blending multiple fuels increased miscibility and a higher cetane value can be achieved without separation. This is enhanced by having a variety of molecule sizes, phase transitions and combustion properties in the same blended solution.

An example of this type of fuel is a high-cetane renewable diesel containing mostly paraffins which is produced by hydrotreating vegetable oil or tallow. Another example is a high-cetane diesel containing mostly paraffins which is produced by catalytic oligomerization of 1-hexene followed by hydrogenation of the oligomers to form a paraffin-rich product. (The 1-hexene feed stock may be derived from either biological or petroleum sources.) These fuels may be used neat or in blends with petroleum-derived fuels such as conventional or high-cetane diesels.

### Example 3

In another embodiment, hydrolyzed biomass polyols are used for condensation reactions to create a RHE-diesel fuel. Polyols used for condensation include glycerol, ethylene glycol, 1,2-propanediol, sugar alcohols, maltitol, sorbitol, xylitol, isomalt, isomers, and combinations of polyols. Condensation reactions can be used to produce ethers (dipentyl and dihexyl ether) made from condensation of alcohols, polyglycol ethers terminated with alkane groups made from condensation of glycols followed by capping with olefins, polyglycol ethers terminated with alkane groups made from condensation of glycols followed by mild hydrodeoxygenation of terminal hydroxyl groups, polyglycol ethers terminated with olefinic groups made from condensation of glycols followed by dehydration of terminal hydroxyl groups, polydiol ethers terminated with alkane groups made from condensation of glycols followed by capping with olefins, polydiol ethers terminated with alkane groups made from condensation of glycols followed by mild hydrodeoxygenation of terminal hydroxyl groups, polydiol ethers terminated with olefinic groups made from condensation of glycols followed by dehydration of terminal hydroxyl groups, mixed ethers, acetals, hemiacetals, dehydrated hemiacetals formed by dehydrogenation of hydroxyl containing compounds, and combinations thereof.

The ability to develop RHE-diesel fuels is essential to continue improving emission qualities for diesel fuels. Although many green development options have been proposed, gasoline engines, hybrids, and electric vehicles still produce large quantities of carbon dioxide, either at the tailpipe or at the electric plant. Diesel fuels could dramatically reduce pollution because of the increase combustion efficiency, lower emissions, and ability to use a wider range of fuel sources.

In closing, it should be noted that the discussion of any reference is not an admission that it is prior art to the present invention, especially any reference that may have a publication date after the priority date of this application. At the same time, each and every claim below is hereby incorporated into this detailed description or specification as a additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

### REFERENCES

All of the references cited herein are expressly incorporated by reference. The discussion of any reference is not an admission that it is prior art to the present invention, especially any reference that may have a publication data after the priority date of this application. Incorporated references are listed here for convenience:
1. U.S. App. No. 61/375,334, “Advanced Diesel Combustion With Low Hydrocarbon And Carbon Monoxide Emissions,” filed on Aug. 20, 2010.
2. Akihama, et al., “Mechanism of the Smokeless Rich Diesel Combustion by Reducing Temperature.” SAE Paper 2001-01-0655 (2001).
3. Asanuma, et al., “Effect of Sulfur-Free and Aromatics-Free Diesel Fuel on Vehicle Exhaust Emissions using Simultaneous PM and NOx Reduction Systems.” SAE Paper 2003-01-1865 (2003).
4. AVL, AVL Concerto SoftVersion 3.9 Software Guide. In 2006; Vol. AT1635E Rev. 03.
5. Bielaczyc, et al., “Effects of Fuel Properties on Exhaust Emissions from the Latest Light-Duty Di Diesel Engine.” SAE Paper 2003-01-1882 (2003).
6. Briker, et al., “Diesel Fuel Analysis by GC-FIMS: Normal Paraffins, Isoparaffins, and Cycloparaffins,” Energy & Fuels 15:996-1002 (2001).
7. Chen and Sperling, “Case Study of Light-Duty Diesel Vehicles in Europe.” California Air Resources Board, Final Report, Contract 02-310, Project No. 008545 (2004).
8. Cho, et al., Experimental investigation of the effects of fuel characteristics on high efficiency clean combustion (HECC) in a light-duty diesel engine. SAE Paper 2009-01-2669 (2009).
9. Dec, “A Conceptual Model of DI Diesel Combustion Based on Laser-Sheet Imaging.” SAE Paper 970873 (1997).
10. Fujimoto, et al., “Exhaust Emission Through Diesel Combustion of Mixed Fuel Oil Composed of Fuel With High Volatility and That with Low Volatility.” SAE Paper 2004-01-1845 (2004).
11. Ghosh, “Predicting the Effect of Cetane Improvers on Diesel Fuels,” Energy & Fuels, 22:1073-1079 (2008).
12. Hardenberg and Ehnert, “Ignition quality determination problems with alternative fuels for compression ignition engines,” SAE Paper 811212 (1981).
13. Indritz, “What Is Cetane Number?” Prep. Am. Chem. Soc. Div. Pet. Chem., 30:282 (1985).
14. Kawamoto, et al., “Combination of Combustion Concept and Fuel Property for Ultra-Clean DI Diesel.” SAE Paper 2004-01-1868 (2004).
15. Kitano, et al., “Effects of Fuel Properties on Premixed Charge Compression Ignition Combustion in a Direct Injection Diesel Engine.” SAE Paper 2003-01-1815 (2003).
16. Nishiumi, et al., “Effects of Cetane Number and Distillation of Paraffinic Diesel Fuels on PM Emission from a DI Diesel Engine.” SAE Paper 2004-01-2960 (2004).
17. Ogawa and Okada, “Influence of Properties and Composition of Diesel Fuels on Particulate Emissions: Part 2. Fuels for Single-Cylinder Engine Test in the Combustion Analysis for the WG of JCAP” R&D Review of Toyota CRDL 38:54-67 (2003).
18. Schmidt's Diesel Car Prospects to 2013 (2010).
19. Suppes, et al., “Impact of cetane improvers on ignition delay times of several alternative biofuels. Bioenergy '96 The Seventh National Bioenergy Conference. Southeastern Regional Biomass Energy Program, 1996b; p 377.
20. Suppes, et al.,. “Cetane-Improver Analysis and Impact of Activation Energy on the Relative Performance of 2-Ethylhexyl Nitrate and Tetraethylene Glycol Dinitrate.” Ind. Eng. Chem. Res. 36:4397-404 (1997).
21. Yang, et al., “Neural Network Prediction of Cetane Numbers for Isoparaffins and Diesel Fuel.” Petr. Sci. Technol. 19:573 (2001).
22. Zannis, et al., “Experimental Study of Diesel Fuel Effects on Direct Injection (DI) Diesel Engine Performance and Pollutant Emissions.” Energy & Fuels 21:2642-54 (2007).

1. A renewable high-efficiency diesel (RHE-diesel) fuel comprising a high paraffin diesel comprising hydrotreated triglycerides including tallow or vegetable oil.

2. The RHE-diesel fuel of claim 1, wherein the high-efficiency diesel fuel comprises:
a) short chain paraffins selected from the group consisting of C8, C9, C10, C11, C12, C13, C14, or C15 paraffins,
b) long chain paraffins selected from the group consisting of C15, C16, C17, C18, C19, C20, C21, C22, C23, C24, C25 or C26 isoparaffins, wherein the sidechains have 1-5 carbons in each of the sidechains, and less than 50 percent of the total carbons are in sidechains,
c) long chain esters, ethers and hemiacetals (C₈₋₂₆) selected from the group consisting of methyl esters, 1,2-ethanediols, 1,3-propanediols, 1,4-butanediols, 2,3-butanediols, and the like, said long chain esters, ethers and hemiacetals containing a total of 10, 11, 12, 13, 14, 15, 16, 17, 18, 19, 20, 21, 22, 23, 24, 25 or 26 carbon atoms in a linear or branched chain with oxygen,
d) condensation products of alcohols, polyols, carboxylic acids, and fatty acids,
e) ethers (dipentyl and dihexyl ether) made from condensation of alcohols, polyglycol ethers terminated with alkane groups made from condensation of glycols followed by capping with olefins, polyglycol ethers terminated with alkane groups made from condensation of glycols followed by mild hydrodeoxygenation of terminal hydroxyl groups, polyglycol ethers terminated with olefinic groups made from condensation of glycols followed by dehydration of terminal hydroxyl groups, polydiol ethers terminated with alkane groups made from condensation of glycols followed by capping with olefins, polydiol ethers terminated with alkane groups made from condensation of glycols followed by mild hydrodeoxygenation of terminal hydroxyl groups, polydiol ethers terminated with olefinic groups made from condensation of glycols followed by dehydration of terminal hydroxyl groups, mixed ethers, acetals, hemiacetals, dehydrated hemiacetals formed by dehydrogenation of hydroxyl containing compounds, or
f) combinations thereof.

3. The RHE-diesel fuel of claim 1, wherein the RHE-diesel fuel has:
a) a cetane number great then that of conventional diesel fuel, including a cetane number of about 51 to about 81, including a high efficiency diesel fuel with a derived cetane number of about 60, about 65, about 70, about 75, about 80, about 45 to 51, about 51 to 81, or above about 81, or greater than 85,
b) a combustion efficiency of from 98.19% to 98.69%, reduced NO_{X} emissions from 0.63 g/kg_{fuel} to 2.01 g/kg_{fuel}, reduced particulate matter emissions of from 0.45 g/kg_{fuel} to 0.71 g/kg_{fuel}, reduced total hydrocarbon emissions of from 2.01 g/kg_{fuel} to 3.69 g/kg_{fuel}, reduced carbon monoxide emissions of from 8.62 g/kg_{fuel} to 13.98 g/kg_{fuel},
c) an increase in brake thermal efficiency of greater than 1.0%, including at least 1.5%, compared to an identical method wherein the fuel is a conventional diesel fuel,
d) a decrease in nitrogen oxide (NOₓ) emissions of greater than 10%, including at least about 17%, 18%, 19%, 20% or greater, compared to an identical method wherein the fuel is a diesel fuel,
e) a decrease in particulate matter emissions of greater than 55%, including about 63%, 65%, 68%, 70%, or greater, compared to an identical method wherein the fuel is a diesel fuel,
f) a decrease in total hydrocarbon emissions of greater than 75%, including at least about 80%, 85% 90% or greater, compared to an identical method wherein the fuel is a diesel fuel,
g) a decrease in carbon monoxide emissions of greater than 70%, including greater than 75%, 80%, or greater, compared to an identical method wherein the fuel is a diesel fuel, or
h) combinations thereof.

4. The RHE-diesel fuel according of claim 1, wherein the fuel is blended diesel fuel stock comprising one or more components including a RHE-diesel fuel, a cetane enhancer, an LTFT fuel, high-cetane distillates, high-cetane straight-run distillate, high-cetane overhead products, paraffins, isoparaffins, ethyl hexyl nitrate (EHN), and combinations thereof.

5. A renewable high-efficiency diesel (RHE-diesel) fuel comprising esters, ethers and/or hemiacetals comprising alcohols, polyols and combinations thereof.

6. The RHE-diesel fuel of claim 5, wherein the high-efficiency diesel fuel comprises:
a) short chain paraffins selected from the group consisting of C8, C9, C10, C11, C12, C13, C14, or C15 paraffins,
b) long chain paraffins selected from the group consisting of C15, C16, C17, C18, C19, C20, C21, C22, C23, C24, C25 or C26 isoparaffins, wherein the sidechains have 1-5 carbons in each of the sidechains, and less than 50 percent of the total carbons are in sidechains,
c) long chain esters, ethers and hemiacetals (C₈₋₂₆) selected from the group consisting of methyl esters, 1,2-ethanediols, 1,3-propanediols, 1,4-butanediols, 2,3-butanediols, and the like, said long chain esters, ethers and hemiacetals containing a total of 10, 11, 12, 13, 14, 15, 16, 17, 18, 19, 20, 21, 22, 23, 24, 25 or 26 carbon atoms in a linear or branched chain with oxygen,
d) condensation products of alcohols, polyols, carboxylic acids, and fatty acids,
e) ethers (dipentyl and dihexyl ether) made from condensation of alcohols, polyglycol ethers terminated with alkane groups made from condensation of glycols followed by capping with olefins, polyglycol ethers terminated with alkane groups made from condensation of glycols followed by mild hydrodeoxygenation of terminal hydroxyl groups, polyglycol ethers terminated with olefinic groups made from condensation of glycols followed by dehydration of terminal hydroxyl groups, polydiol ethers terminated with alkane groups made from condensation of glycols followed by capping with olefins, polydiol ethers terminated with alkane groups made from condensation of glycols followed by mild hydrodeoxygenation of terminal hydroxyl groups, polydiol ethers terminated with olefinic groups made from condensation of glycols followed by dehydration of terminal hydroxyl groups, mixed ethers, acetals, hemiacetals, dehydrated hemiacetals formed by dehydrogenation of hydroxyl containing compounds, or
f) combinations thereof.

7. The RHE-diesel fuel of claim 5, wherein the RHE-diesel fuel has:
a) a cetane number great then that of conventional diesel fuel, including a cetane number of about 51 to about 81, including a high efficiency diesel fuel with a derived cetane number of about 60, about 65, about 70, about 75, about 80, about 45 to 51, about 51 to 81, or above about 81, or greater than 85,
b) a combustion efficiency of from 98.19% to 98.69%, reduced NO_{X} emissions from 0.63 g/kg_{fuel} to 2.01 g/kg_{fuel}, reduced particulate matter emissions of from 0.45 g/kg_{fuel} to 0.71 g/kg_{fuel}, reduced total hydrocarbon emissions of from 2.01 g/kg_{fuel} to 3.69 g/kg_{fuel}, reduced carbon monoxide emissions of from 8.62 g/kg_{fuel} to 13.98 g/kg_{fuel},
c) an increase in brake thermal efficiency of greater than 1.0%, including at least 1.5%, compared to an identical method wherein the fuel is a conventional diesel fuel,
d) a decrease in nitrogen oxide (NOₓ) emissions of greater than 10%, including at least about 17%, 18%, 19%, 20% or greater, compared to an identical method wherein the fuel is a diesel fuel,
e) a decrease in particulate matter emissions of greater than 55%, including about 63%, 65%, 68%, 70%, or greater, compared to an identical method wherein the fuel is a diesel fuel,
f) a decrease in total hydrocarbon emissions of greater than 75%, including at least about 80%, 85% 90% or greater, compared to an identical method wherein the fuel is a diesel fuel,
g) a decrease in carbon monoxide emissions of greater than 70%, including greater than 75%, 80%, or greater, compared to an identical method wherein the fuel is a diesel fuel, or
h) combinations thereof.

8. The RHE-diesel fuel according of claim 5, wherein the fuel is blended diesel fuel stock comprising one or more components including a RHE-diesel fuel, a cetane enhancer, an LTFT fuel, high-cetane distillates, high-cetane straight-run distillate, high-cetane overhead products, paraffins, isoparaffins, ethyl hexyl nitrate (EHN), and combinations thereof.

9. A renewable high-efficiency diesel (RHE-diesel) fuel blending agent comprising:
a) a high paraffin diesel comprising hydrotreated triglycerides including tallow or vegetable oil, and
b) esters, ethers and hemiacetals comprising alcohols, polyols and combinations thereof.

10. The RHE-diesel fuel of claim 9, wherein the high-efficiency diesel fuel comprises:
a) short chain paraffins selected from the group consisting of C8, C9, C10, C11, C12, C13, C14, or C15 paraffins,
b) long chain paraffins selected from the group consisting of C15, C16, C17, C18, C19, C20, C21, C22, C23, C24, C25 or C26 isoparaffins, wherein the sidechains have 1-5 carbons in each of the sidechains, and less than 50 percent of the total carbons are in sidechains,
c) long chain esters, ethers and hemiacetals (C₈₋₂₆) selected from the group consisting of methyl esters, 1,2-ethanediols, 1,3-propanediols, 1,4-butanediols, 2,3-butanediols, and the like, said long chain esters, ethers and hemiacetals containing a total of 10, 11, 12, 13, 14, 15, 16, 17, 18, 19, 20, 21, 22, 23, 24, 25 or 26 carbon atoms in a linear or branched chain with oxygen,
d) condensation products of alcohols, polyols, carboxylic acids, and fatty acids,
e) ethers (dipentyl and dihexyl ether) made from condensation of alcohols, polyglycol ethers terminated with alkane groups made from condensation of glycols followed by capping with olefins, polyglycol ethers terminated with alkane groups made from condensation of glycols followed by mild hydrodeoxygenation of terminal hydroxyl groups, polyglycol ethers terminated with olefinic groups made from condensation of glycols followed by dehydration of terminal hydroxyl groups, polydiol ethers terminated with alkane groups made from condensation of glycols followed by capping with olefins, polydiol ethers terminated with alkane groups made from condensation of glycols followed by mild hydrodeoxygenation of terminal hydroxyl groups, polydiol ethers terminated with olefinic groups made from condensation of glycols followed by dehydration of terminal hydroxyl groups, mixed ethers, acetals, hemiacetals, dehydrated hemiacetals formed by dehydrogenation of hydroxyl containing compounds, or
f) combinations thereof.

11. The RHE-diesel fuel of claim 9, wherein the RHE-diesel fuel has:
a) a cetane number great then that of conventional diesel fuel, including a cetane number of about 51 to about 81, including a high efficiency diesel fuel with a derived cetane number of about 60, about 65, about 70, about 75, about 80, about 45 to 51, about 51 to 81, or above about 81, or greater than 85,
b) a combustion efficiency of from 98.19% to 98.69%, reduced NO_{X} emissions from 0.63 g/kg_{fuel} to 2.01 g/kg_{fuel}, reduced particulate matter emissions of from 0.45 g/kg_{fuel} to 0.71 g/kg_{fuel}, reduced total hydrocarbon emissions of from 2.01 g/kg_{fuel} to 3.69 g/kg_{fuel}, reduced carbon monoxide emissions of from 8.62 g/kg_{fuel} to 13.98 g/kg_{fuel},
c) an increase in brake thermal efficiency of greater than 1.0%, including at least 1.5%, compared to an identical method wherein the fuel is a conventional diesel fuel,
d) a decrease in nitrogen oxide (NOₓ) emissions of greater than 10%, including at least about 17%, 18%, 19%, 20% or greater, compared to an identical method wherein the fuel is a diesel fuel,
e) a decrease in particulate matter emissions of greater than 55%, including about 63%, 65%, 68%, 70%, or greater, compared to an identical method wherein the fuel is a diesel fuel,
f) a decrease in total hydrocarbon emissions of greater than 75%, including at least about 80%, 85% 90% or greater, compared to an identical method wherein the fuel is a diesel fuel,
g) a decrease in carbon monoxide emissions of greater than 70%, including greater than 75%, 80%, or greater, compared to an identical method wherein the fuel is a diesel fuel, or
h) combinations thereof.

12. The RHE-diesel fuel according of claim 9, wherein the fuel is blended diesel fuel stock comprising one or more components including a RHE-diesel fuel, a cetane enhancer, an LTFT fuel, high-cetane distillates, high-cetane straight-run distillate, high-cetane overhead products, paraffins, isoparaffins, ethyl hexyl nitrate (EHN), and combinations thereof.

13. A method for reducing the emissions of a diesel engine, the method comprising
a) combusting a fuel, wherein the fuel is a renewable high-efficiency diesel (RHE-diesel) fuel selected from fuels comprising:
i) a high paraffin diesel comprising hydrotreated triglycerides including tallow or vegetable;
ii) esters, ethers and hemiacetals comprising alcohols, polyols and combinations thereof; and
iii) combinations thereof;
wherein the RHE-diesel fuel is injected at from −8 to 0 degrees After Top Dead Center (ATDC), and
b) operating the engine with an exhaust gas recirculation (EGR) of from 20 to 60%.

14. The RHE-diesel fuel of claim 13, wherein the high-efficiency diesel fuel comprises:
a) short chain paraffins selected from the group consisting of C8, C9, C10, C11, C12, C13, C14, or C15 paraffins,
b) long chain paraffins selected from the group consisting of C15, C16, C17, C18, C19, C20, C21, C22, C23, C24, C25 or C26 isoparaffins, wherein the sidechains have 1-5 carbons in each of the sidechains, and less than 50 percent of the total carbons are in sidechains,
c) long chain esters, ethers and hemiacetals (C₈₋₂₆) selected from the group consisting of methyl esters, 1,2-ethanediols, 1,3-propanediols, 1,4-butanediols, 2,3-butanediols, and the like, said long chain esters, ethers and hemiacetals containing a total of 10, 11, 12, 13, 14, 15, 16, 17, 18, 19, 20, 21, 22, 23, 24, 25 or 26 carbon atoms in a linear or branched chain with oxygen,
d) condensation products of alcohols, polyols, carboxylic acids, and fatty acids,
e) ethers (dipentyl and dihexyl ether) made from condensation of alcohols, polyglycol ethers terminated with alkane groups made from condensation of glycols followed by capping with olefins, polyglycol ethers terminated with alkane groups made from condensation of glycols followed by mild hydrodeoxygenation of terminal hydroxyl groups, polyglycol ethers terminated with olefinic groups made from condensation of glycols followed by dehydration of terminal hydroxyl groups, polydiol ethers terminated with alkane groups made from condensation of glycols followed by capping with olefins, polydiol ethers terminated with alkane groups made from condensation of glycols followed by mild hydrodeoxygenation of terminal hydroxyl groups, polydiol ethers terminated with olefinic groups made from condensation of glycols followed by dehydration of terminal hydroxyl groups, mixed ethers, acetals, hemiacetals, dehydrated hemiacetals formed by dehydrogenation of hydroxyl containing compounds, or
f) combinations thereof.

15. The RHE-diesel fuel of claim 13, wherein the RHE-diesel fuel has:
a) a cetane number great then that of conventional diesel fuel, including a cetane number of about 51 to about 81, including a high efficiency diesel fuel with a derived cetane number of about 60, about 65, about 70, about 75, about 80, about 45 to 51, about 51 to 81, or above about 81, or greater than 85,
b) a combustion efficiency of from 98.19% to 98.69%, reduced NO_{X} emissions from 0.63 g/kg_{fuel} to 2.01 g/kg_{fuel}, reduced particulate matter emissions of from 0.45 g/kg_{fuel} to 0.71 g/kg_{fuel}, reduced total hydrocarbon emissions of from 2.01 g/kg_{fuel} to 3.69 g/kg_{fuel}, reduced carbon monoxide emissions of from 8.62 g/kg_{fuel} to 13.98 g/kg_{fuel},
c) an increase in brake thermal efficiency of greater than 1.0%, including at least 1.5%, compared to an identical method wherein the fuel is a conventional diesel fuel,
d) a decrease in nitrogen oxide (NOₓ) emissions of greater than 10%, including at least about 17%, 18%, 19%, 20% or greater, compared to an identical method wherein the fuel is a diesel fuel,
e) a decrease in particulate matter emissions of greater than 55%, including about 63%, 65%, 68%, 70%, or greater, compared to an identical method wherein the fuel is a diesel fuel,
f) a decrease in total hydrocarbon emissions of greater than 75%, including at least about 80%, 85% 90% or greater, compared to an identical method wherein the fuel is a diesel fuel,
g) a decrease in carbon monoxide emissions of greater than 70%, including greater than 75%, 80%, or greater, compared to an identical method wherein the fuel is a diesel fuel, or
h) combinations thereof.

16. The RHE-diesel fuel of claim 13, wherein the fuel is blended diesel fuel stock comprising one or more components including a RHE-diesel fuel, a cetane enhancer, an LTFT fuel, high-cetane distillates, high-cetane straight-run distillate, high-cetane overhead products, paraffins, isoparaffins, ethyl hexyl nitrate (EHN), and combinations thereof.
